(19) United States
(12) Patent Application Publication
(10) Pub. No.: US 2007/0289606 A1
(43) Pub. Date: Dec. 20, 2007

(54) Multi-pin fiber connector cleaning apparatus

(76) Inventors: Robert Abrahamian, Glendale, CA (US); Lawrence van der Vegt, Newbury Park, CA (US)

Correspondence Address: Michael N. Cohen;Suite 301, 9025 Wilshire Blvd., Beverly Hills, CA, 90211, US

(21) Appl. No.: 11/818,761

(22) Filed: Jun. 15, 2007

Related U.S. Application Data
(60) Provisional application No. 60/814,339, filed on Jun. 16, 2006.

(51) Int. Cl. B08B 1/00

(52) U.S. Cl. 134/6; 15/210.1; 15/244.1

(57) ABSTRACT

A multi-pin fiber connector cleaning apparatus and method for cleaning and removal of contamination of multi-pin connectors is disclosed. The apparatus and method includes a handle portion, a tool portion, a specially formulated and disposable foam cleaning pad, a cloth cleaning pad and a cloth cleaning pad container. The apparatus is pushed onto ferrules inside a connector shell wherein the contaminants located on the ferrules adhere to the adhesive nature of the cleaning pads which allows all the ferrules in the connector to be clean in one forward movement on to the ferrules and one withdrawing movement away from the ferrules. The tool portion may have various shapes and sizes such as oval, circular, square or other shapes and sizes in order to accommodate the type of connector to be cleaned.

### CROSS-REFERENCE TO RELATED APPLICATIONS

This application claims benefit of U.S. provisional patent application Ser. No. 60/814,339, filed by Applicants Robert Abrahamian and Lawrence van der Vegt, on Jun. 16, 2006.

### STATEMENT REGARDING FEDERALLY SPONSORED RESEARCH AND DEVELOPMENT

Not Applicable.

### FIELD OF THE INVENTION

The present invention generally relates to an apparatus and method for cleaning and removal of contamination of multi-pin connectors.

### DISCUSSION OF RELATED ART

Optical fibers are quickly replacing wires for the transmission of data in the electronics industry. Not only are the fibers small, but light data transmission rates are very high in comparison to those of wire connections. Fiber optic cables may contain one or more of these optical fibers. Connectors are used to mate several optical fibers or cables as well as to connect such cables to backplanes and system cards of computer and telecommunication systems.

A problem existing with these connectors is that dust and debris deposited between mating ferrules contaminate the connectors. Specifically, the optical transmission capability of the junction between the optical fibers can be significantly impaired by microscopically small deposits of contamination on the end surfaces of the fibers. Small amounts of contamination in the form of particles or haze will significantly reduce light attenuation across the butted connection. Therefore, it is essential that the end surfaces be cleaned before the optical fiber ends are connected to each other, and/or after they become contaminated during normal use.

Prior art practice in the maintenance of optical fiber connectors is to rub the ferrule end against a fabric- or paper-based cleaning strip. Conventionally, the polished end face of an optical connector is wiped with a soft cloth or paper before the connection is made. Another method involves applying ethanol to the cleaning cloth or paper and then using a compressed gas, such as a fluorocarbon gas, to remove the remaining ethanol and dust from the cloth or paper from the connection surface. This method requires the ferrule end to be fully exposed for proper cleaning, but this is often impractical because the ferrule end is often recessed within a connector or coupler and it would be necessary to disassemble the connector or coupler in order to clean the ferrule end. These methods provide the best cleaning surfaces only along the outside diameter of the swab, i.e., on its sides, and not on the end. Thus, when inserted in the connector, coupler or bulkhead, the best cleaning performance will be along connector sidewalls, not where needed on the ferrule ends. The result is inadequate or incomplete cleaning of the ferrule end connection. This process creates problems of efficiency in the manner in which it is cleaned and tends to be extremely lengthy in time, lasting anywhere from three to thirty minutes with the possibility of damaging the ferrules.

Therefore, a need exists for an apparatus to clean the multi-pin connector within a fraction of time as compared to the traditional means. There is also a need for the ability to have differing materials, degrees, and adhesiveness of pads necessary for the cleaning of more serious contamination of ferrules. Further, the apparatus should clean all the ferrules inside the multi-pin optic fiber or electrical connector by one push/pull means. The present invention accomplishes these objectives.

### SUMMARY OF THE INVENTION

The present invention is an apparatus and method for cleaning and removal of contamination of multi-pin connectors. The apparatus includes a handle portion, a tool portion connected to a pad portion, a specially formulated and disposable foam cleaning pad, a cloth cleaning pad and a cloth cleaning pad container. The tool portion is connected to a handle portion wherein the tool end is comprised of a foam pad and a cloth pad mounting surface. The tool end may have various shapes and sizes such as oval, circular, square or other shapes and sizes in order to accommodate the type of connector to be cleaned.

The foam pad comprises of a protective top layer which acts as a seal to protect the adhesive nature of a cleaning tape portion and a protective bottom layer. The bottom protective layer of the foam pad is removed and bottom portion of the foam pad is mounted onto the tool end. The top protective layer is removed to expose the top adhesive portion of the foam pad. The top adhesive portion is then pushed into the ferrules of the connector. Force is applied onto the foam pad by applying a forward pressure from the handle for approximately three seconds to remove contamination of ferrules.

The cloth turn pad typically comprises a top cleaning cloth connected to a bottom tape laminate. The tape laminate connects to the foam pad of the present invention. The cloth turn pads are held in a container. The container has a top enclosure cap, a closed bottom and a foam that keeps the pads in place under all circumstances independent from the quantity stored.

In another embodiment, the present invention provides for a method of contaminant removal in the case of hard-core contamination. The top enclosure of the cloth turn pad container is removed and held at 45 degree angle. The tool end with the foam pad attached to it inside the container is pressed against the cloth turn pad until they are firmly attached. The tool end is then inserted inside the connector and pressed with little force while turning the apparatus 45 to 90 degrees. The apparatus is then removed from the connector and the used cloth turn pad is removed and may be discarded. The apparatus employs a push/pull clean mechanism to remove contamination of ferrules.

The foregoing enumeration of embodiments has been for illustrative purposes only. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating a multi-pin fiber connector cleaning apparatus.

FIG. 2 is a schematic view of the invention, illustrating a handle portion with a tool portion.

FIG. 3A-3D is a schematic view of the alternative embodiments of the invention, illustrating various foam pad shapes and cloth pad mounting surfaces.

FIG. 4 is a top view of the invention, illustrating a cloth turn pad.

FIG. 4A is a front view of the invention, illustrating the round version of the cloth turn pad.

FIG. 5 is a lateral cross-sectional view of the invention, illustrating a cloth pad container for placing round cloth turn pads.

FIG. 6 is a schematic view of the invention, illustrating the attachment and use of foam pad.

FIG. 6A is a front view of the invention, illustrating the foam pad.

FIG. 7 is a schematic view illustrating the attachment of foam pad to the tool end, in accordance with a preferred embodiment.

FIG. 8 is a schematic view illustrating the attachment of cloth turn pad to foam pad at the tool end, in accordance with an alternate embodiment.

FIG. 9 is a perspective view of the invention, illustrating the general operation of the multi-pin fiber connector cleaning apparatus.

FIG. 10A-10B is an illustration depicting an expanded perspective of the ferrules before and after the use of the present invention.

### DETAILED DESCRIPTION OF THE PREFERRED EMBODIMENT

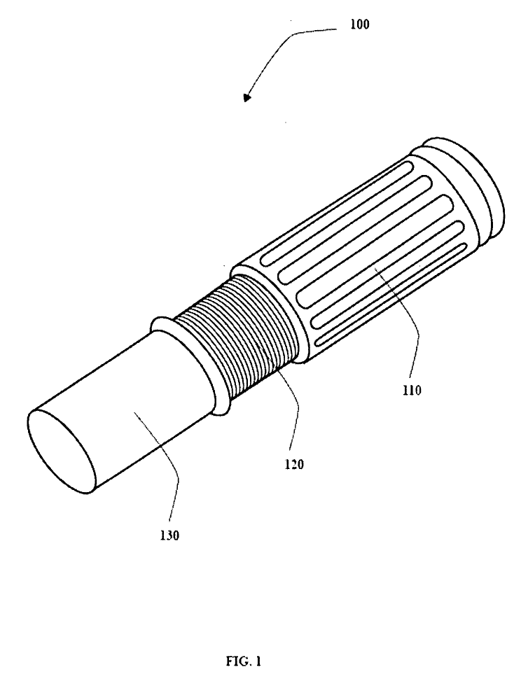

Referring to FIG. 1, illustrated is a multi-pin fiber connector cleaning apparatus 100 for cleaning and removal of contamination of multi-pin connectors. The apparatus 100 includes a handle portion 110 and a tool portion 120 connected to a pad portion 130.

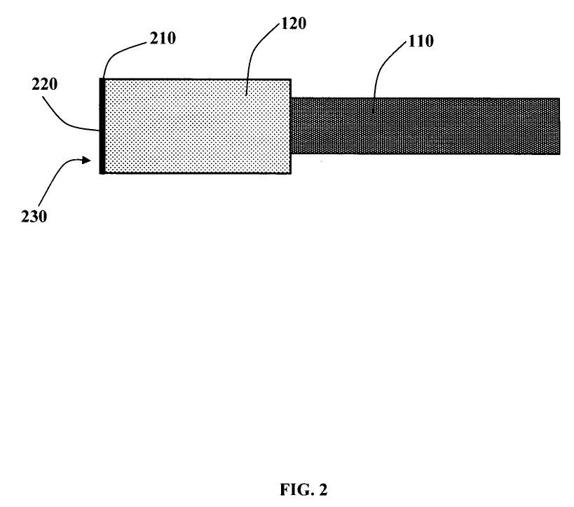

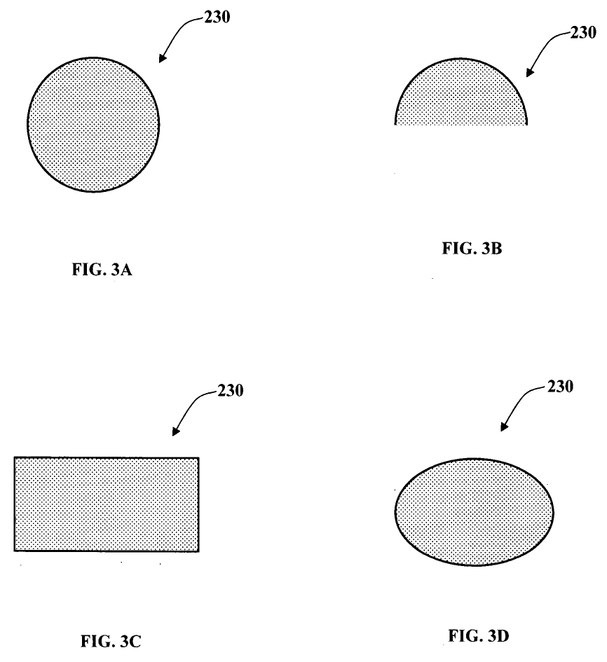

Referring to FIG. 2, the tool portion 120 comprises a tool end 210. The tool end 210 is comprised of a specially formulated and disposable foam cleaning pad 220 and a cloth cleaning pad mounting surface 230. The tool end 210 is connected to the handle portion 110. The cloth pad mounting surface 230 can have various shapes and sizes such as oval, circular, square or other shapes and sizes as shown in FIG. 3A-3D in order to accommodate the type of connector to be cleaned. The present invention can clean a range of ferrule types including but not limited to FLAT, PC, and APC.

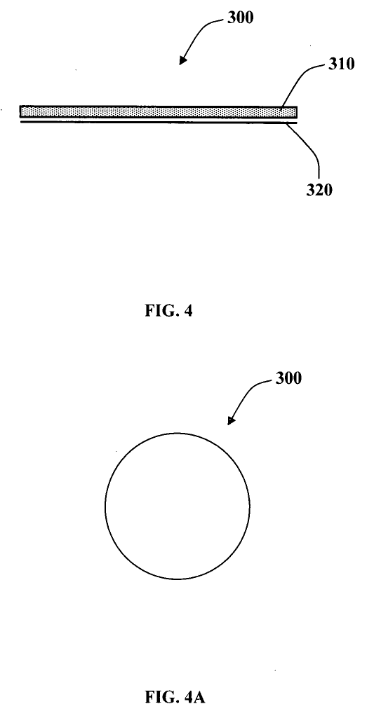

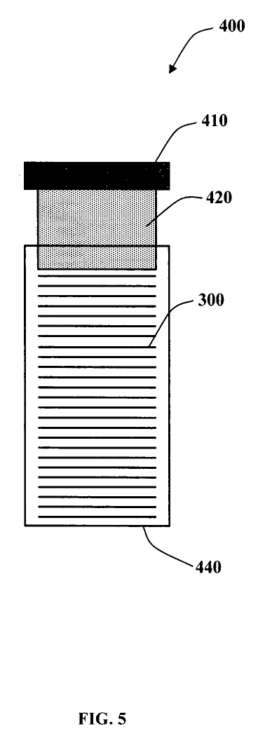

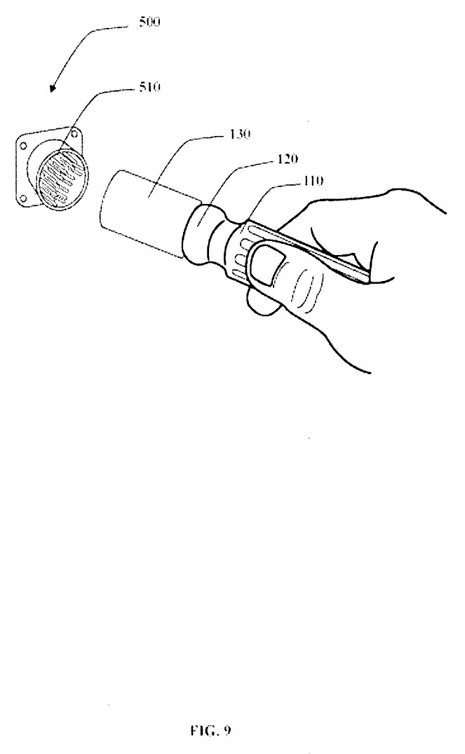

Referring to FIG. 4, a top view of a cloth turn pad 300 is illustrated. The cloth turn pad 300 typically comprises a top cleaning cloth 310 connected to a tape laminated bottom 320. The top cleaning cloth 310 is the cleaning surface that cleans all the ferrules 510 inside the connector 500 as shown in FIG. 9. The tape laminated bottom 320 is connected to the foam cleaning pad 220. Referring to FIG. 4A a side view of a round version of the cloth turn pad 300 is illustrated. The cloth turn pads 300 are held in a cloth pad container 400 as shown in FIG. 5. The cloth pad container 400 has a top enclosure 410, a closed bottom 440 and a foam 420 that keeps the cloth turn pads 300 in place under all circumstances independent of the quantity stored. The cloth turn pads 300 are positioned with the tape laminated bottom 320 upward and top cleaning cloth 310 downward within the cloth pad container 400. The cloth pad container 400 is typically a transparent plastic container.

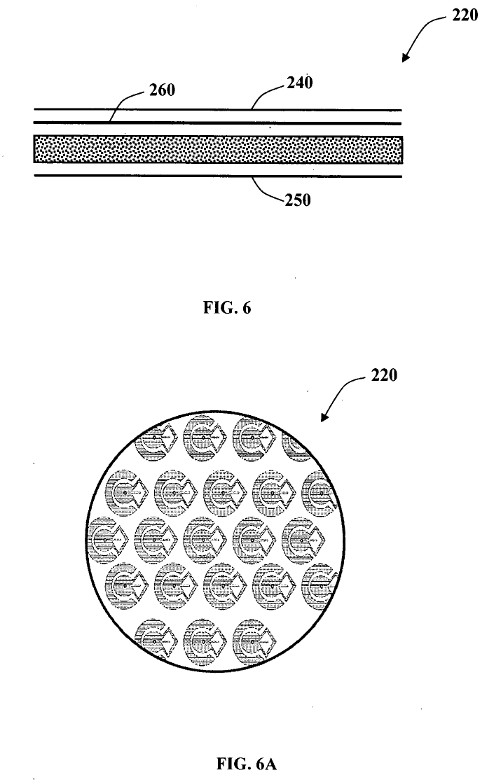

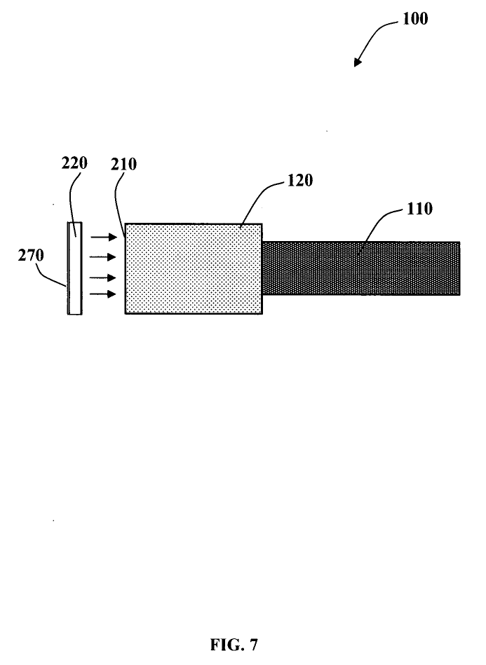

Referring to FIG. 6 a schematic view of the attachment and use of the foam cleaning pad 220 is illustrated. The foam cleaning pad 220 comprises a protective top layer 240 which acts as a seal to protect the adhesive nature of a cleaning tape portion 260 of the foam cleaning pad 220 prior to use. Removal of the protective top layer 240 uncovers the top adhesive portion 270 of the cleaning tape portion 260. A bottom protective layer 250 of the foam cleaning pad 220 is adhesive and connects to the tool end 210. The cleaning tape portion 260 sits on top of the foam cleaning pad 220. The protective bottom layer 250 has a blank paper (not shown). Referring to FIG. 6A a front view of the foam cleaning pad 220 is illustrated. The protective bottom layer 250 of the foam cleaning pad 220 is removed and mounted onto the tool end 210 as shown in FIG. 7. The protective top layer 240 is removed to expose the top adhesive portion 270 of the foam pad 220. The top adhesive portion 270 is then pushed into the ferrules 510 of the connector 500 as shown in FIG. 9. Force is applied onto the foam cleaning pad 220 by applying a forward pressure from the handle portion 110 for approximately three seconds. The apparatus 100 is retracted from the connector 500. Test results have shown that this procedure cleans ferrules in 90% of all cases.

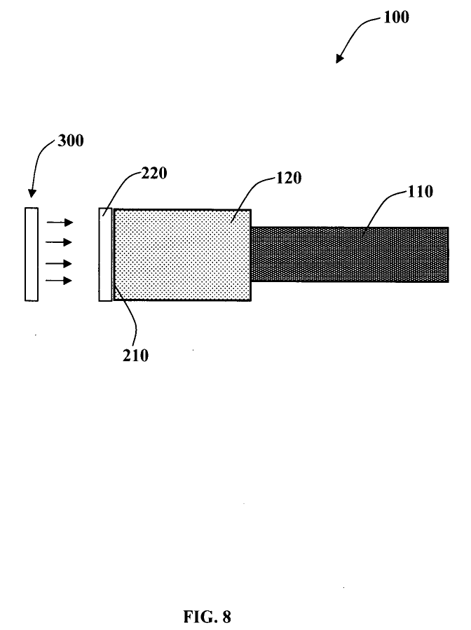

Referring to FIG. 8 a schematic view of the attachment of cloth turn pad 300 to foam cleaning pad 220 at the tool end 210 to remove hard-core contamination is illustrated, in accordance with an alternate embodiment. The top enclosure 410 from the cloth turn pad container 400 is removed and held at a 45 degree angle. The tool end 210 with the foam cleaning pad 220 still attached to it inside the cloth pad container 400 is pressed against the cloth turn pad 300 until they are firmly attached. The tool end 210 is then inserted inside the connector 500 and pressed with little force while turning the apparatus 100 45 to 90 degrees. The apparatus 100 is then removed from the connector 500 and the used cloth turn pad 300 is removed and may be discarded.

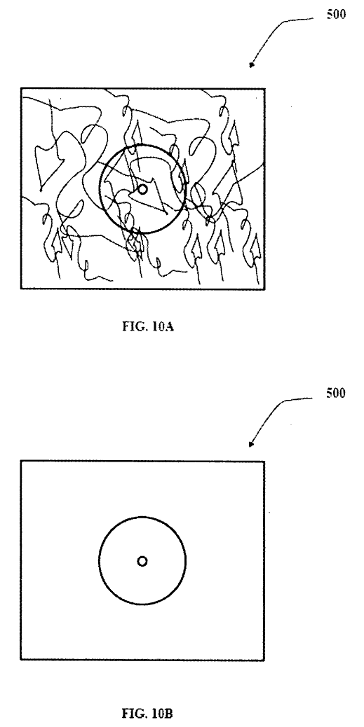

Referring to FIG. 9, a user grasps the handle portion 110 of the apparatus 100, which has the tool portion 120 connected to the handle portion 110. The user pushes the apparatus 100 into a connector 500, causing the cleaning surface of the foam cleaning pad 220 on the tool end 210 to come into contact with the ferrules 510 of the connector 500. The user applies pressure to the apparatus 100 for a short period of time and then withdraws or pulls away the apparatus 100. As shown in FIG. 7, the action of applying pressure to the apparatus 100 causes the ferrules 510 to be clean by adhering to the cleaning tape portion 260 of the tool end 210. As such, contaminants from the ferrules 510 are transferred from the ferrules 510 to the cleaning tape portion 260 of the tool end 210. Referring to FIG. 10A-10B an expanded perspective of the ferrules 510 before and after the use of the present invention is illustrated. The multi-pin fiber connector cleaning apparatus 100 cleans the ferrules 510 inside the connector 500 as shown in FIG. 10B.

The release of the cleaning apparatus 100 makes cleaning of multi-pin fiber optic connector 500 simple, quick and efficient in a fraction of time. There is no need to disassemble or reassemble mission critical connector components for cleaning purposes. The apparatus 100 is based on specially formulated and disposable pads 220 and 310 which clean all ferrules 510 inside the connector 500 by one push/pull after which the pad 310 can be discarded and a new one applied ready for the next cleaning job.

The apparatus 100 supports most popular multi-pin optic fiber connectors currently deployed in harsh environment applications, such as expanded beam connectors etc and offers custom sizes and models. The features include one push/pull mechanism to clean all ferrules in one go for optimized cleaning, cloth turn pads 300 can be used for removing hard core contamination. Various models are available for any connector size, various kit configurations available, cleaning unlimited to the number of ferrules in a connector, simple yet effective and durable design.

The anticipated markets for the present invention contemplate but are not limited to industrial use, government and defense, avionics, aerospace, medical, automotive, tele-communications, data communications, and broadband. Typical applications of the present invention contemplate but are not limited to product manufacturing, installation, and maintenance. The foregoing enumeration of embodiments has been for illustrative purposes only. Other embodiments, combinations of embodiments and combinations of features are also within the scope and spirit of the teachings described herein, as will be apparent to persons skilled in the art of these teachings.

While a particular form of the invention has been illustrated and described, it will be apparent that various modifications can be made without departing from the spirit and scope of the invention. Accordingly, it is not intended that the invention be limited, except as by the appended claims.

What is claimed is:

1. A multi-pin connector cleaning apparatus for cleaning and removal of contamination of a multi-pin connector, comprising:
a handle portion;
a tool portion connected with said handle portion, wherein said tool portion having a tool end comprising at least one pad portion;
whereby said multi-pin connector is cleaned by applying a forward pressure to said handle portion causing said at least one pad portion on said tool end to come in contact with a plurality of ferrules of said multi-pin connector.

2. The multi-pin connector cleaning apparatus of claim 1 wherein said at least one pad portion includes a foam cleaning pad and a cloth cleaning pad, said cloth cleaning pad includes a tape laminated bottom and a cleaning cloth for cleaning and removal of hard core contamination of said multi-pin connector.

3. The multi-pin connector cleaning apparatus of claim 1 wherein said tool end comprises a plurality of shapes and a plurality of sizes in order to accommodate different types of said multi-pin connector to be cleaned.

4. The multi-pin connector cleaning apparatus of claim 1 wherein said foam cleaning pad includes a top protective layer and a bottom protective layer, whereby removal of said top protective layer expose a top adhesive portion of said foam cleaning pad and removal of said bottom protective layer mounts said foam cleaning pad onto said tool portion.

5. The multi-pin connector cleaning apparatus of claim 4 wherein said top adhesive portion is pushed into said plurality of ferrules of said multi-pin connector by applying a forward pressure to said handle portion.

6. The multi-pin connector cleaning apparatus of claim 1 further comprising a cloth cleaning pad container for storing said cloth cleaning pad, comprising:
a top enclosure for closing said cloth cleaning pad container,
a foam that keeps said cloth cleaning pad in place under all circumstances independent from the quantity stored; and
a closed bottom;
whereby said cloth cleaning pad container is typically transparent and plastic in texture.

7. The multi-pin connector cleaning apparatus of claim 6 wherein said cloth cleaning pad positioned inside said cloth cleaning pad container is held at an angle enhancing said tool portion comprising said foam cleaning pad to be pressed against said cloth cleaning pad.

8. The multi-pin connector cleaning apparatus of claim 1 wherein said cloth cleaning pad and said foam cleaning pad cleans said plurality of ferrules inside said multi-pin connector by one push/pull clean mechanism after which said cloth cleaning pad is discarded.

9. A method for cleaning and removal of contamination of a multi-pin connector, comprising:
providing a handle portion;
providing a tool portion mating with said handle portion, wherein said tool portion having a tool end comprising at least one pad portion;
whereby said multi-pin connector is cleaned by applying a forward pressure to said handle portion causing said at least one pad portion on the tool end to come in contact with a plurality of ferrules of said multi-pin connector.

10. The method of claim 9 wherein said at least one pad portion includes a foam cleaning pad and a cloth cleaning pad, said cloth cleaning pad includes a tape laminated bottom and a cleaning cloth for cleaning and removal of hard contamination of said multi-pin connector.

11. The method of claim 9 wherein said tool portion comprises a plurality of shapes and a plurality of sizes in order to accommodate different types of said multi-pin connector to be cleaned.

12. The method of claim 9 wherein said foam cleaning pad includes a top protective layer and a bottom protective layer, whereby removal of said top protective layer exposes a top adhesive portion of said foam cleaning pad and removal of bottom protective layer mount said foam cleaning pad onto said tool portion.

13. The method of claim 9 wherein said top adhesive portion is pushed into said plurality of ferrules of said multi-pin connector by applying a forward pressure to said handle portion.

14. The method for cleaning and removal of contamination of said multi-pin connector further comprising providing a cloth cleaning pad container for storing said cloth cleaning pad, comprising:
providing a top enclosure for closing said cloth cleaning pad container,
providing a foam that keeps said cloth cleaning pad in place under all circumstances independent from the quantity stored; and
a closed bottom;
whereby said cloth cleaning pad container is typically transparent and plastic in texture.

15. The method of claim 14 wherein said cloth cleaning pad positioned inside said cloth cleaning pad container is held at an angle enhancing said tool end comprising said foam cleaning pad to be pressed against said cloth cleaning pad.

16. The method of claim 9 wherein said foam cleaning pad and said cloth cleaning pad cleans said plurality of ferrules inside said multi-pin connector by one push/pull clean mechanism after which said cloth cleaning pad is discarded.
